(19) United States
(12) Patent Application Publication
(10) Pub. No.: US 2003/0191645 A1
(43) Pub. Date: Oct. 9, 2003

(54) Statistical pronunciation model for text to speech

(76) Inventor: Guojun Zhou, Portland, OR (US)

Correspondence Address: Pillsbury Winthrop LLP, Intellectual Property Group, 1600 Tysons Boulevard, McLean, VA, 22102, US

(21) Appl. No.: 10/115,935

(22) Filed: Apr. 5, 2002

(51) Int. Cl. G10L 13/08

(52) U.S. Cl. 704/260

(57) ABSTRACT

An arrangement is provided for speech synthesis using statistical pronunciation models established based on annotated training data. When input text is received, pronunciations of words in the input text are determined based on the use of relevant statistical pronunciation models. The speech signal corresponding to the input text is then synthesized using the determined pronunciations.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to automated speech processing systems. Other aspects of the present invention relate to voice synthesis.

In a society that is becoming increasingly “information anywhere and anytime”, voice enabled information services emerge everyday to provide various types of information to users around the clock. Examples of such services include weather information, movie information, or train reservation information services, etc. Requested information may be provided in speech form instead of conventional text form. This is especially required when the user who requests the information does not have a platform on which returned textual information can be displayed. For example, a user may ask for information about train schedules over a cellular phone. The requested information may be retrieved and sent to the user in speech form via cellular phone rather than in the text form in which it may have been stored and retrieved. Technologies used to enable voice based information services may include text to speech, through which textual information (e.g., train schedules) can be converted to its corresponding speech form.

In conventional text to speech, to generate audible speech from text, the text is first converted into a sequence of pronunciation units that can then be synthesized to produce understandable speech message. Such pronunciation units may be phonemes or diphones which are a concatenation of phonemes The sequence of pronunciation units (or phonemems) corresponds to the pronunciations of a sequence of words or characters. For example, to convert an input text “The train from Munich to Berlin departs from Munich at 8:00am every day on platform A.” to its speech form, the pronunciation of each word or character (e.g., character “A”) is determined first. Each determined pronunciation may be represented as a sequence of phonemes.

Problems may arise when a word potentially has more than one pronunciation and a correct pronunciation of the word in a specific sentence may depend on different factors, including its context or the part-of-speech of the word. For example, consider the word “record” in the sentence “I asked my secretary to record the notes of the conference.” The word has a different pronunciation from that of the same word in the sentence “I asked my secretary to find the record of the conference' notes.”. In this particular example, the pronunciation of the word “record” is related to whether its part-of-speech is a verb or a noun. As another example, the word “St.” in sentence “St. Petersburg is a beautiful city.” has a different pronunciation from that of the same word in the sentence “The hospital is located on Petersburg St.”. In this case, the pronunciation is determined according to its context, specifically whether the word “St.” is followed by a name or is following a name.

The traditional solution to determine a pronunciation in text to speech is to devise a set of pronunciation rules. In the “record” example, a rule regarding the pronunciation of the word “record” may be: “If word ‘record’ appears in context as a verb, it should be pronounced X. If word ‘record’ appears in context as a noun, it should be pronounced Y. In the “St.” example, a pronunciation rule may be: “If ‘St.’ is followed by a name, it should be pronounced A. If ‘St.’ follows a name, it should be pronounced B.”. The first rule requires that the part-of-speech of the word “record” be unambiguously identified (i.e., with absolute certainty); while the second rule requires that the part-of-speech of surrounding words (proceeding and following words) be unambiguously determined.

In real automated speech processing systems, the part-of-speech of a word often cannot be determined with absolute certainty. For example, the tense of verb “read” in input text “I read the article.” may be past tense or present tense. In this case, since one can not infer the tense of the verb with absolute certainty, the part-of-speech of verb “read” (i.e., whether it is a past tense or present tense) needed to determine its pronunciation can not be determined. Subsequently, the correct pronunciation of the word “read” cannot be determined either. An ambiguous situation may also arise when a sentence is not composed grammatically correct or an automated speech processing system provides no definite classification (e.g., only statistical classification) of the part-of-speech of each word in a sentence. In both situations, the correct pronunciation of a word cannot be unambiguously determined. This causes most conventional text-to-speech systems to either generate speech with incorrect pronunciations or sometimes lead to a complete failure.

### BRIEF DESCRIPTION OF THE DRAWINGS

The present invention is further described in terms of exemplary embodiments, which will be described in detail with reference to the drawings. These embodiments are non-limiting exemplary embodiments, in which like reference numerals represent similar parts throughout the several views of the drawings, and wherein:

FIG. 1 shows a high level framework for speech synthesis based on statistical pronunciation models, according to embodiments of the present invention;

FIG. 2 is a high level functional block diagram of a statistical pronunciation modeling mechanism, according to embodiments of the present invention;

FIG. 3 is a high level functional block diagram of a speech synthesis mechanism that uses statistical pronunciation models to determine pronunciation, according to embodiments of the present invention;

FIG. 4 is a flowchart of an exemplary process, in which speech synthesis is performed based on pronunciations determined according to statistical pronunciation models, according to an embodiment of the present invention;

FIG. 5 is a flowchart of an exemplary process, in which training data is annotated with pronunciations with respect to context of words to generate annotated training data, according to an embodiment of the present invention;

FIG. 6 is a flowchart of an exemplary process, in which statistical pronunciation models are generated based on annotated training data, according to an embodiment of the present invention; and

FIG. 7 is a flowchart of an exemplary text to speech process, which determines pronunciations of words based on statistical pronunciation models, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

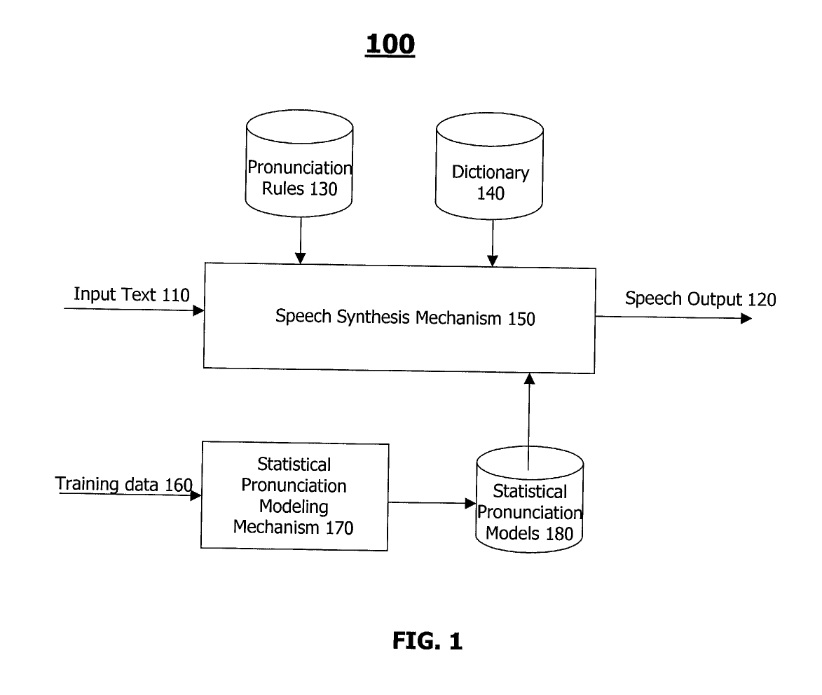

FIG. 1 depicts a high level framework 100 for speech synthesis based on statistical pronunciation models, according to embodiments of the present invention. The speech synthesis mechanism 150 in the framework 100 takes an input text 110 as input and generates a corresponding speech of the input text 110, speech output 120, as output. The speech synthesis mechanism 150 produces the speech output 120 based on the pronunciations of the words in the input text 110 determined using pronunciation rules 130 and statistical pronunciation models 180 and retrieved from a dictionary 140. The statistical pronunciation models 180 are established by a statistical pronunciation modeling mechanism 170 based on training data 160.

The input text 110 may correspond to a textual sequence of words, some of which may be associated with a plurality of pronunciations. The speech output 120 represents a continuous speech signal corresponding to the spoken words contained in the input text 110. Each of the spoken words in the speech output 120 (corresponding to a section of the speech signal) is synthesized or generated based on a pronunciation of the word, retrieved from the dictionary 140. A pronunciation stored in the dictionary 140 may be represented as a sequence of pronunciation units (which may correspond to phonemes or diphones).

The pronunciation of a word in a particular input text may differ when the context in which the word appears is different. For example, the pronunciation of the word “record” in the input text “The secretary is asked to record the conference notes.” is different from the pronunciation of the same word in the input text “The secretary is asked to find the record of the conference notes.” The word “record” in the first input text is a verb and that in the second input text is a noun. Therefore, when the two input texts are used to synthesize their corresponding speech form, the corresponding occurrences of the word “record” are synthesized according to different pronunciations.

A pronunciation of a word in an input text may be determined according to the context in which the word occurs. In the above example, depending on whether the word “record” is a verb or a noun, its correct pronunciation may be identified. A different kind of context which may be used to determine the pronunciation of a word. In the input texts “St. Petersburg is a beautiful city” and “The hospital is located on Petersburg St.”, the first instance of the word “St.” appears immediately before a name and the second instance appears immediately after a name. The pronunciation of the first instance corresponds to “Saint” and that of the second instance corresponds to “street”.

The context that determines a pronunciation of a word may be described using different approaches. Accordingly, the association between a context and a specific pronunciation may also be characterized differently. For example, the association may be specified using either concrete rules or statistical probabilities. Associating verb “record” with one pronunciation and a noun “record” with another pronunciation may be specified as a rule. In terms of when it is appropriate to use may depend on whether the part-of-speech of a word can be classified with certainty. For example, if the part-of-speech of the word “record” can be determined unambiguously, a discrete rule may be used to associate a verb “record” with one pronunciation and associating noun “record” with another.

A statistical approach may be applied to determine a pronunciation when the context required to determine a pronunciation of a word can not be classified with absolute certainty. For example, the tense of verb “read” in input text “I read the article” may be past tense or present tense. Since one can not infer the tense of the verb with absolute certainty, the part-of-speech of verb “read” may be determined statistically at best. In this case, the pronunciation of the word can only be inferred from its part-of-speech statistically. Such situation may arise when a sentence is not composed grammatically correct or an automated parser may provide only statistical classification of the part-of-speech of each word in a sentence. Consequently, the correct pronunciation of a word may be determined statistically at best.

The speech synthesis framework 100 provides both pronunciation rules 130 and statistical pronunciation models 180 to assist the speech synthesis mechanism 150 to determine the pronunciation of each word in input text 110. The pronunciation rules 130 specify concrete rules to determine a pronunciation of a word. For example, a rule governing the determination of the pronunciation of the word “record” may be expressed equivalent to “If it is a verb, take pronunciation X. If it is a noun, take pronunciation Y.”.

The statistical pronunciation models 180 represent models that associate a specific context (e.g., the part-of-speech of a word) statistically with a corresponding pronunciation. Such statistical models are generated by the statistical pronunciation modeling mechanism 170 based on given training data 160. The training data 160 may represent a meaningful population that provides various instances of different part-of-speech of a particular word. Based on the training data 160, statistical analysis may be performed and statistical properties of a given population may be characterized in the form of statistical models, which are used to guide the process of selecting appropriate pronunciations of words.

The speech synthesis mechanism 150 may use the statistical pronunciation models 180 either alone, when corresponding pronunciation rules do not exist, or in combination with the pronunciation rules 130 to determine an appropriate pronunciation of a word. Once a pronunciation is determined, the speech synthesis mechanism 150 retrieves the pronunciation from the dictionary 140 to enable the synthesis of the acoustic signal of the underlying word. For that purpose, each pronunciation in the dictionary 140 may be represented as a sequence of phonemes, expressed as a textual string (e.g., in its digital form). Using a sequence of phonemes of a pronunciation, the speech synthesis mechanism 150 accordingly produces an acoustic signal of the pronunciation of the underlying word.

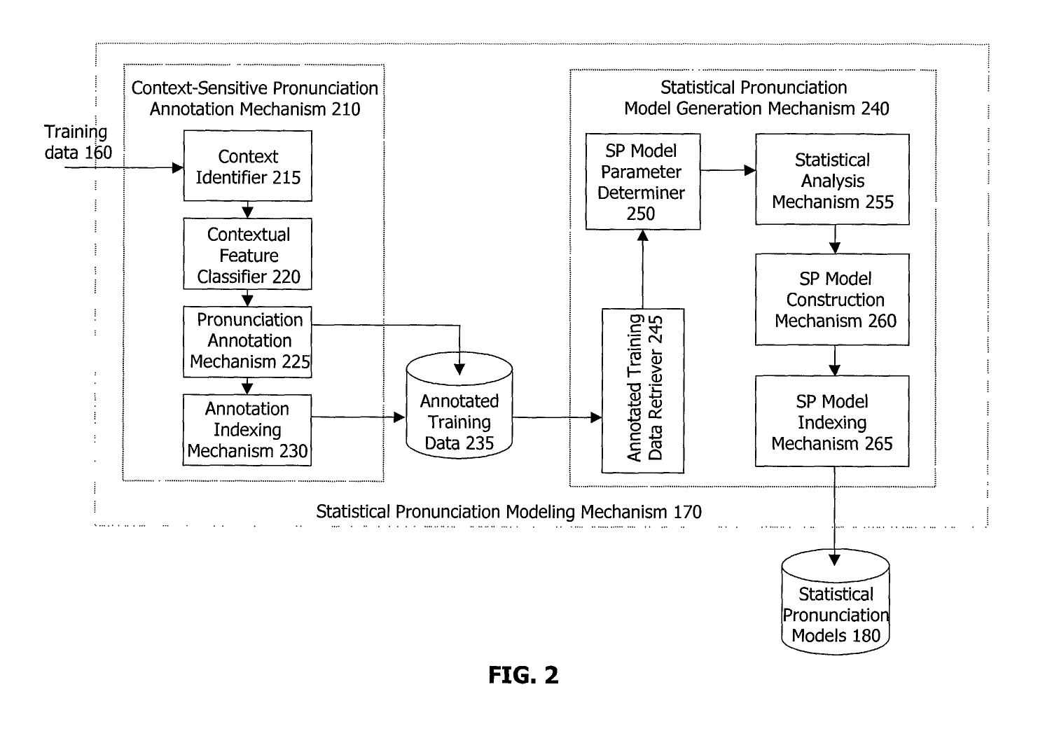

FIG. 2 depicts a high-level functional block diagram of the statistical pronunciation modeling mechanism 170, according to embodiments of the present invention. The statistical pronunciation modeling mechanism 170 comprises a context-sensitive pronunciation annotation mechanism 210, which generates annotated training data 235 based on given training data 160, and a statistical pronunciation model generation mechanism 240, which generates statistical pronunciation models based on the annotated training data 235.

The context-sensitive pronunciation annotation mechanism 210 annotates the pronunciations of words in the training data 160 with respect to certain contextual features. It may annotate the training data 160 according to what is needed by the statistical pronunciation model generation mechanism 240 to facilitate the derivation of statistical models. For example, to derive a statistical model for each of the pronunciations of a word, the training data 160 may be annotated not only with respect to pronunciations of the word but also the characteristic contexts in which different pronunciations arise. For instance, the pronunciation “Saint” in “St. Petersburg” may be annotated together with the particular context of a name immediately following the “St.”. This provides the statistical pronunciation model generation mechanism 240 the basis to perform correlation analysis to capture the association between the pronunciation “saint” and the context of “immediately followed by a name.”.

The context-sensitive pronunciation annotation mechanism 210 comprises a context identifier 215, a contextual feature identifier 220, a pronunciation annotation mechanism 225, and an annotation indexing mechanism 230. The context identifier 215 identifies a context associated with a word that may be relevant to a proper pronunciation of the word. The relevance of a context of a particular word may be determined such that it contains some distinguishing contextual features that may be used to derive a proper pronunciation of the word in an input text. For example, an appropriate context for the word “St.” may be defined as the words immediately before and after the word “St.”, whichever applies.

The contextual feature identifier 220 identifies and annotates some specific features in a specified context that may provide discriminative power in determining an appropriate pronunciation. Using the example of the word “St.”, in the context of adjacent words, useful contextual features such as “immediately before”, “immediately after”, or “the word is a name” may be specifically annotated. These contextual features describe the surrounding of “St.” and can be used to derive useful statistical characterization of the correlation between such features and the correct pronunciation of the word “St.”.

The pronunciation annotation mechanism 225 annotates the pronunciation of a word given some particular contextual features surrounding the word. The pronunciation may be annotated in connection with the annotated contextual features. The annotation indexing mechanism 230 may establish appropriate index of generated annotations to facilitate efficient access and retrieval. For example, an index may be established for all instances of annotated pronunciations of “St.” and different pronunciations may be further based on contextual features. The established indices, together with the annotated words and features, may then be stored as the annotated training data 235.

The statistical pronunciation model generation mechanism 240 accesses the annotated training data 235 and characterizes the annotated training data 235 via statistical analysis. To support such functionalities, the statistical pronunciation model generation mechanism 240 may comprise, at least some of but not limited to, an annotation training data retriever 245, a statistical model parameter determiner 250, a statistical analysis mechanism 255, a statistical pronunciation model construction mechanism 260, and a statistical pronunciation model indexing mechanism 265.

When the annotated training data retriever 245 retrieves the annotated training data 235, the statistical pronunciation model parameter determiner 250 may determine the necessary parameters used to characterize the statistical correlation between a pronunciation and its contextual features. Such parameters may be used to determine the statistical models to be derived from the annotated training data 235. For example, a statistical pronunciation model may characterize the statistical property of a particular pronunciation in terms of a probability given its contextual features such as P(word 1 being pronounced as X if it follows word 2) (the probability of word 1 being pronounced as X when it follows word 2).

With model parameters determined, the statistical analysis mechanism 255 performs statistical analysis on the annotated training data 235 with respect to these parameters. For example, the statistical analysis mechanism 255 may analyze the annotated training data 235 to compute, for each underlying word, the distribution of pronunciation of a word with respect to its different contextual features. A collection of such distributions provides a basis for the statistical pronunciation model construction mechanism 260 to generate models. For example, based on the pronunciation distribution of a particular word, the statistical pronunciation model construction mechanism 260 may derive the probabilities of different pronunciations with respect to different contextual features.

The generated statistical pronunciation models may be stored using indices to facilitate efficient retrieval. The statistical pronunciation model indexing mechanism 265 establishes indices for statistical pronunciation models. For example, all the probabilities (i.e., models) related to the pronunciations of a word may be indexed under the word itself. A hierarchy of indices may also be established so that probabilities corresponding to different contextual features may be accessed directly.

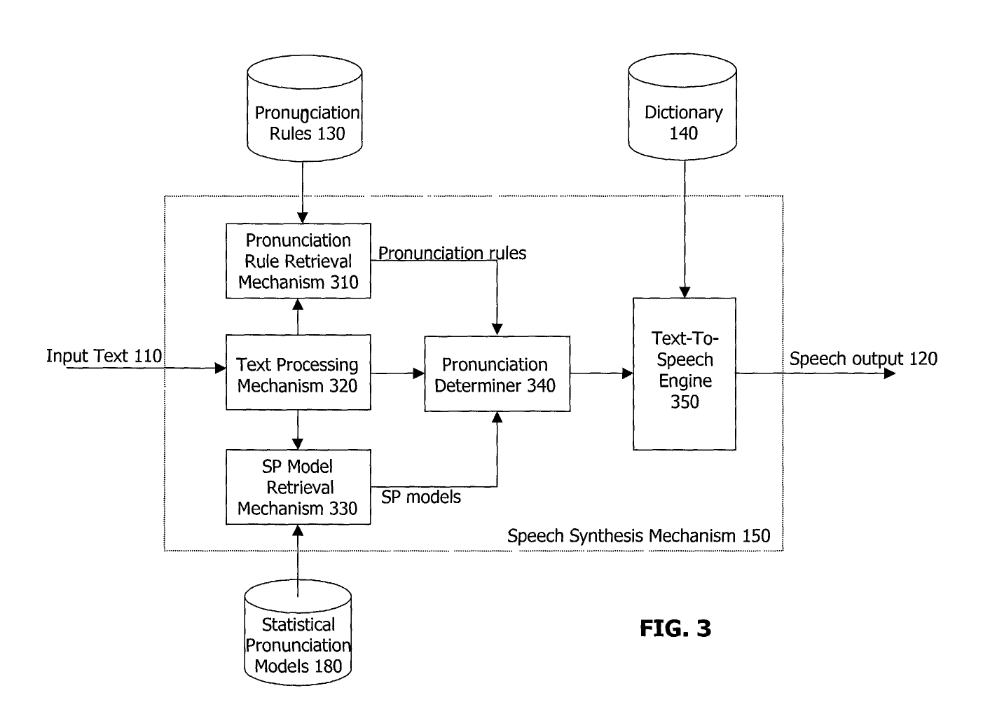

FIG. 3 depicts a high-level functional block diagram of the speech synthesis mechanism 150 that uses statistical pronunciation models 180, either alone or together with the pronunciation rules 130, to determine appropriate pronunciations of words, according to embodiments of the present invention. The speech synthesis mechanism 150 comprises a text processing mechanism 320, a pronunciation rule retrieval mechanism 310, a statistical pronunciation model retrieval mechanism 330, a pronunciation determiner 340, and a text to speech engine 350. The text processing mechanism 320 receives the input text 110 and processes it to identify context features that are relevant in selecting pronunciation rules or statistical pronunciation models to be retrieved in order to determine the pronunciations of the words in the input text 110. Appropriate contextual features are sent to either the pronunciation rule retrieval mechanism 310 or the statistical pronunciation model retrieval mechanism 330 (or both) to access relevant rules or models.

The pronunciation determiner 340 receives the retrieved pronunciation rules or statistical pronunciation models (or both) and determines an appropriate pronunciation of each of the words in the input text 110. Some word may have only one pronunciation (e.g., the word “we”). In this case, there may be no rule or model needed to determine the pronunciation. When a word has more than one potential pronunciation, a particular pronunciation appropriate with respect to the context of the word needs to be selected. In this case, the pronunciation determiner 340 may rely on some relevant pronunciation rules or statistical pronunciation models or both to determine the appropriate pronunciation.

When the pronunciation determiner 340 selects appropriate pronunciations of the words of the input text 110, it sends the selected pronunciations, in an order in accordance with the order of the corresponding words, to the text-to-speech engine 350. Based on the list of selected pronunciations, the text-to-speech engine 350 retrieves each of the pronunciations (each of which may be represented as a sequence of phonemes) from the dictionary 140 and synthesizes the speech output 120 using the retrieved pronunciations.

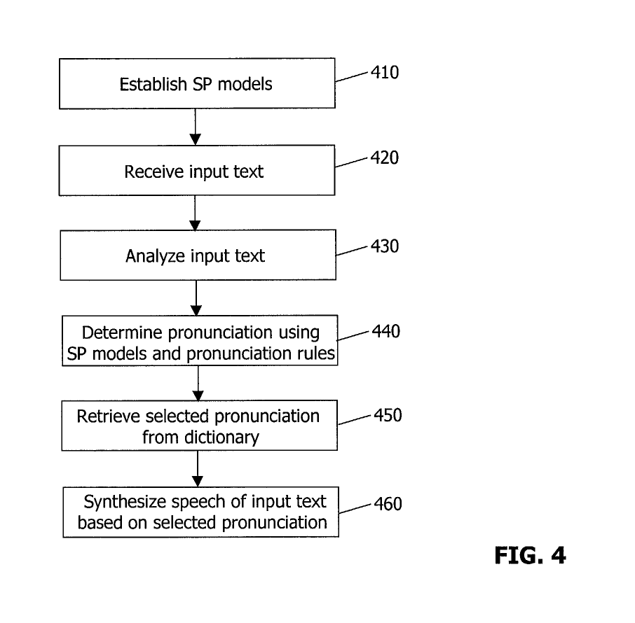

FIG. 4 is an exemplary flowchart of a process, in which speech synthesis is performed based on pronunciations determined according to the statistical pronunciation models 180 and the pronunciation rules 130, according to an embodiment of the present invention. The statistical pronunciation models 180 are established first at act 410 based on the annotated training data 235. The input text 110 is received at act 420. The input text 110 is analyzed, at act 430, to identify relevant contextual features. Based on the contextual features, associated statistical pronunciation models as well as pronunciation rules, if any, are retrieved and used to determine, at act 440, the appropriate pronunciations of the words in the input text 110. The determined pronunciations are then retrieved, at act 450, from the dictionary 140 and used to synthesize, at act 460, the speech form of the input text 110.

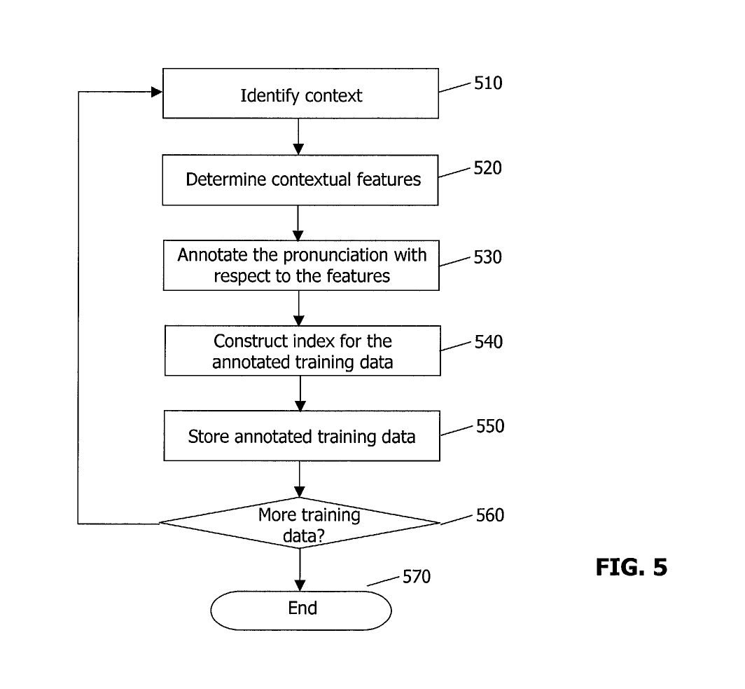

FIG. 5 is an exemplary flowchart of a process, in which the training data 160 is annotated with pronunciations with respect to context of words to generate the annotated training data 235, according to an embodiment of the present invention. For each word in the training data 160 whose pronunciations are to be modeled, a context containing relevant features that determine the pronunciation of the word is identified first at act 510. A word whose pronunciation needs to be annotated may correspond to a word that has more than one potential pronunciation and each pronunciation may be determined with respect to its associated contextual features. It may be true that not every word in the training data 160 whose pronunciation needs to be annotated. For example, the word “we” does not have more than one pronunciation and its pronunciation does not depend on its context. In this case, even though a particular sentence in the training data 160 may contain the word “we”, there may be no need to annotate it for the purposes of statistically modeling the pronunciation.

Within the identified context of a word (identified at act 510), relevant contextual features are determined at act 520. Such contextual features may also be accordingly annotated. The pronunciation of the word is then annotated, at act 530, with respect to the context features. Appropriate indices to the annotated data may be constructed, at act 540, to facilitate retrieval of the annotated data and then stored, at act 550, with its corresponding annotated data. The process of annotating a pronunciation of a word repeats until all the words whose pronunciations need to be annotated, are enumerated, determined at act 560. At the end of the process, the annotated training data 235 is generated and stored with appropriate indices.

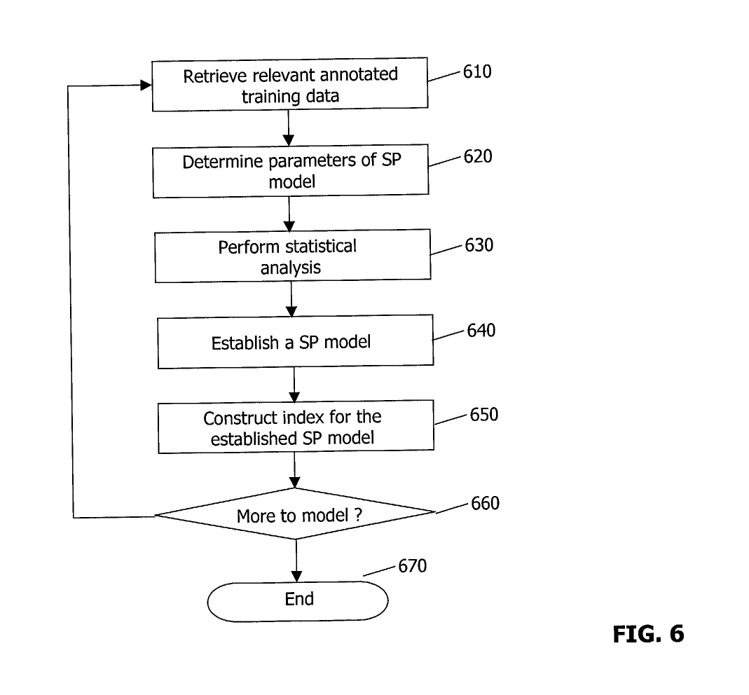

FIG. 6 is an exemplary flowchart of a process, in which the statistical pronunciation models 180 are generated based on the annotated training data 235, according to an embodiment of the present invention. To statistically model a pronunciation of a word, relevant pieces of annotated training data is retrieved first at act 610. For example, if the pronunciations of the word “record” is to be modeled, all pieces of annotated data related to the word “record” in the annotated training data 235 are retrieved based on an index constructed using, for example, the word “record”. Some of the annotated instances corresponding to the word “record” may be related to one pronunciation and others related to the other pronunciation. Each annotated pronunciation may also be associated with a set of contextual features.

To generate a statistical model for a pronunciation of a word, the instances of the retrieved annotated data corresponding to the pronunciation to be modeled are analyzed. To do so, the parameters of a model to be generated are determined, at act 620. The statistical analysis is performed on the annotated data with respect to the model parameters. For example, to derive a conditional probability for the pronunciation of a noun “record”, the parameters associated with the probability and its conditions may be the part-of-speech of a particular instance of the word “record”. For example, the part-of-speech of one instance may be a noun and a different may be a verb. In this case, the modeling parameters may include the part-of-speech of the word “record”. The statistical analysis may then be performed accordingly on the annotated data with respect to the correlation between the part-of-speech of the word “record” and its pronunciation. A parameter may take other forms. For instance, whether a model is generated as a probability of other statistical forms may also be a modeling parameter.

With the modeling parameters determined, statistical analysis is performed, at act 630, on the retrieved annotated data with respect to the modeling parameters. A statistical pronunciation model may then be established, at act 640, based on the statistical analysis result. To store the model and enable efficient retrieval during speech synthesis, appropriate index to the model may be constructed, at act 650. For example, the pronunciation for a noun “record” may be indexed using combination of the word “record” and a pronunciation label (e.g., “pronunciation 1” may be defined as the pronunciation when the word “record” is used as a noun). The statistical modeling process continues until all what need to be modeled are enumerated, determined at act 660.

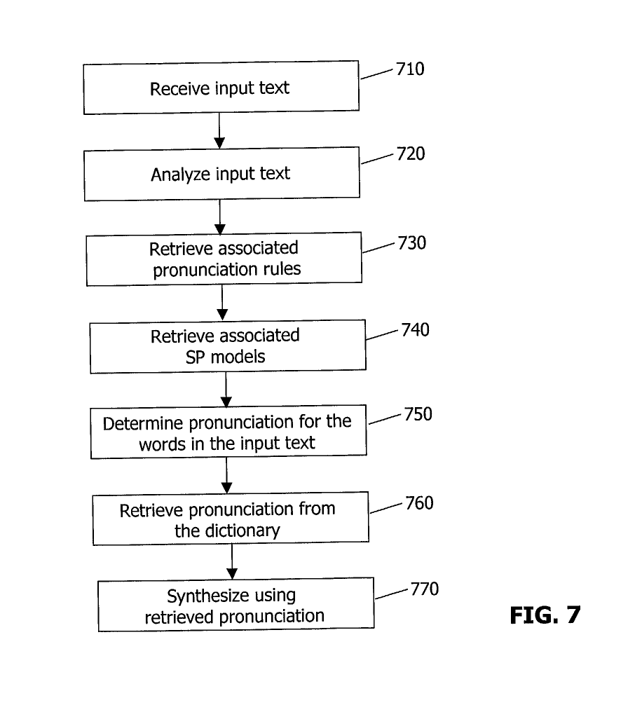

FIG. 7 is an exemplary flowchart of a text-to-speech process, which determines a pronunciation of a word based on combination of statistical pronunciation models and pronunciation rules, according to an embodiment of the present invention. The input text 110 is first received at act 710. To determine the pronunciations of the words in the input text 110, the input text 110 is analyzed at act 720. This may include parsing the input text 110, identify individual words, and distinguish the words whose pronunciations are determinate from the words whose pronunciations are ambiguous.

For a word whose pronunciation is ambiguous, associated pronunciation rules and statistical pronunciation models, if any, are retrieved at acts 730 and 740. Based on retrieved rules and models, the pronunciation of the word is determined, at act 750. Each determined pronunciation may be represented as a label (e.g., “pronunciation 1” of the word “record”). Using the pronunciation label, the corresponding pronunciation (which may be expressed as a series of phonemes) is retrieved, at act 760, from the dictionary 140 and used to synthesize, at act 770, the acoustic form of the word “record” for the context of the input text 110.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments and extends to all equivalent structures, acts, and, materials, such as are within the scope of the appended claims.

What is claimed is:

1. A method, comprising:
establishing at least one statistical pronounciation model based on annotated training data;
receiving input text;
determining a pronounciation of a word in the input text based on zero or more of the statistical pronounciation models; and
synthesizing speech signal corresponding to the input text through synthesizing the acoustic signal of each word in the input text using the pronounciation determined in said determining.

2. The method according to claim 1, wherein said establishing at least one statistical pronounciation model comprises:
retrieving the annotated training data wherein words are annotated in terms of their pronounciations taking into acount of context of the words;
performing statistical analysis of the annotated training data with respect to the context of words; and
building a statistical pronounciation model for each pronounciation of annotated words in the annotated training data based on the statistical analysis.

3. The method acording to claim 1, wherein said determining the pronounciation of a word comprises:
analyzing the input text to determine context of the word in the input text;
selecting a pronounciation of the word according to a statistical pronounciation model of the word that is relevant to the context.

4. The method according to claim 3, wherein said selecting the pronounciation includes determining the pronounciation according to at least one pronounciation rule.

5. The method according to claim 4, further comprising retrieving the selected pronounciation from a dictionary prior to said synthesizing.

6. A method to establish a statistical pronounciation model, comprising:
retrieving annotated training data wherein words are annotated in terms of their pronounciations taking into acount of context of the words;
performing statistical analysis of the annotated training data with respect to the context; and
building a statistical pronounciation model for each pronounciation of the annotated words in the annotated training data based on the statistical analysis.

7. The method according to claim 6, further comprising generating the annotated training data prior to said retrieving.

8. The method according to claim 7, wherein said generating includes:
collecting training data;
determining contextual features of words in the training data whose pronouncitations are to be annotated;
annotating the words in the training data in terms of their pronounciations with respect to their relevant contextual features to generate the annotated training data.

9. A method to synthesizing speech data, comprising:
receiving input text;
analyzing the input text to identify contextual features of words in the input text;
determining a pronounciation of each word according to a statistical pronounciation model of the word relevant to the contextual features of the word; and
synthesizing acoustic signal of the word based on the pronounciation.

10. The method according to claim 9, wherein said selecting the pronounciation includes determining the pronounciation according to at least one pronounciation rule.

11. The method accoring to claim 10, further comprising retrieving the determined pronounciation from a dictionary prior to said synthesizing.

12. A system, comprising:
a statistical pronounciation modeling mechanism for establishing at least one statistical pronounciation model based on annotated training data; and
a speech synthesis mechanism for synthesizing speech from input text based on the statistical pronounciation models.

13. The system according to claim 12, wherein the statistical pronounciation modeling mechanism comprises:
a context sensitive pronounciation annotation mechanism for generating the annotated training data; and
a statistical pronounciation model generation mechanism for creating the statistical pronounciation models based on the annotated training data.

14. The system according to claim 12, further comprising:
at least one pronounciation rule for governing the determination of a pronounciation of a word in the input text; and
a dictionary for storing a plurality of pronounciations.

15. The system according to claim 14, wherein the speech synthesis mechanism comprises:
a text processing mechanism for processing the input text to identify contextual features;
a pronounciation determiner for determining a pronounciation of each word in the input text according to a statistical pronounciation model relevant to the contextual features and the pronounciation rules; and
a text to speech engine for producing acoustic signal for each word in the input text using the pronounciation of each word, retrieved from the dictionary, to generate the speech of the input text.

16. A statistical pronounciation modeling mechanism, comprising:
a context sensitive pronounciation annotation mechanism for generating annotated training data in which words are annotated with their pronounciations; and
a statistical pronounciation model generation mechanism for creating statistical pronounciation models based on the annotated training data.

17. The mechanism according to claim 16, wherein the context sensitive pronounciation annotation mechanism comprises:
a context identifier for identifying relevant context in training data;
a contextual feature identifier for identifying relevant contextual features related to the context; and
a pronouncitation annotation mechanism for annotating pronouncitations of words in the training data with respect to the contextual features to generate the annotated training data.

18. The mechanism according to claim 16, wherein the statistical pronounciation model generation mechanism comprises:
a statistical analysis mechanism for performing statistical analysis on the annotated training data; and
a statistical pronounciation construction mechanism for generating statistical pronounciation models based on the statistical analysis results performed on the annotated training data.

19. A speech synthesis mechanism, comprising:
a text processing mechanism for processing the input text to identify contextual features;
a pronounciation determiner for determining a pronounciation of each word in the input text according to a statistical pronounciation model and the pronounciation rules relevant to the contextual features; and
a text to speech engine for producing acoustic signal for each word in the input text using the pronounciation of each word, retrieved from a dictionary, to generate the speech of the input text.

20. The mechanism according to claim 19, further comprising:
a statistical pronounciation model retrieval mechanism for retrieving a statistical pronounciation model based on the contextual features; and
a pronounciation rule retrieval mechanism for retrieving the pronounciation rules relevant to the contextual features.

21. A machine-accessible medium encoded with data, the data, when accessed, causing:
establishing at least one statistical pronounciation model based on annotated training data;
receiving input text;
determining a pronounciation of a word in the input text based on at least some of the statistical pronounciation models; and
synthesizing speech signal corresponding to the input text through synthesizing the acoustic signal of each word in the input text using the pronounciation determined in said determining.

22. The medium according to claim 21, wherein said establishing at least one statistical pronounciation model comprises:
retrieving the annotated training data wherein words are annotated in terms of their pronounciations taking into acount of context of the words;
performing statistical analysis of the annotated training data with respect to the context of words; and
building a statistical pronounciation model for each pronounciation of annotated words in the annotated training data based on the statistical analysis.

23. The medium acording to claim 21, wherein said determining the pronounciation of a word comprises:
analyzing the input text to determine context of the word in the input text;
selecting a pronounciation of the word according to zero or more statistical pronounciation model of the word and pronunciation rule that are relevant to the context.

24. A machine-accessible medium encoded with data for establishing a statistical pronounciation model, the data, when accessed, causing:
retrieving annotated training data wherein words are annotated in terms of their pronounciations taking into acount of context of the words;
performing statistical analysis of the annotated training data with respect to the context; and
building a statistical pronounciation model for each pronounciation of the annotated words in the annotated training data based on the statistical analysis.

25. The medium according to claim 24, the data, when accessed, further causing generating the annotated training data prior to said retrieving.

26. The medium according to claim 25, wherein said generating includes:
collecting training data;
determining contextual features of words in the training data whose pronouncitations are to be annotated;
annotating the words in the training data in terms of their pronounciations with respect to their relevant contextual features to generate the annotated training data.

27. A machine-accessible medium encoded with data for synthesizing speech data, the data, when accessed, causing:
receiving input text;
analyzing the input text to identify contextual features of words in the input text;
determining a pronounciation of each word according to a statistical pronounciation model of the word relevant to the contextual features of the word; and
synthesizing acoustic signal of the word based on the pronounciation.

28. The medium according to claim 27, wherein said selecting the pronounciation includes determining the pronounciation according to at least one pronounciation rule.

29. The medium accoring to claim 28, the data, when accessed, further causing retrieving the determined pronounciation from a dictionary prior to said synthesizing.
